(19) United States
(12) Patent Application Publication
(10) Pub. No.: US 2003/0186647 A1
(43) Pub. Date: Oct. 2, 2003

(54) Digital satellite broadcast receiver

(76) Inventor: Hitoshi Ikeda, Ikoma-Shi (JP)

Correspondence Address: BIRCH STEWART KOLASCH & BIRCH, PO BOX 747, FALLS CHURCH, VA, 22040-0747, US

(21) Appl. No.: 10/403,049

(22) Filed: Apr. 1, 2003

(30) Foreign Application Priority Data
Apr. 1, 2002 (JP) 2002-098735

(51) Int. Cl. H04H 1/00; H04N 7/20

(52) U.S. Cl. 455/3.02; 725/68

(57) ABSTRACT

With a conventional digital satellite broadcast receiver, it is occasionally impossible to obtain satisfactory reception performance, as under poor reception conditions. To overcome this, the digital satellite broadcast receiver of the invention has a tuner circuit for selecting a broadcast signal of a desired channel from among signals fed thereto, a demodulator circuit for demodulating the broadcast signal selected by the tuner circuit, and a control circuit, having a reception condition evaluator, for controlling the demodulator circuit by varying the settings thereof according to the reception conditions. This makes it possible to obtain satisfactory reception performance under any reception conditions.

### BACKGROUND OF THE INVENTION

1. Field of the Invention

The present invention relates to a digital satellite broadcast receiver.

2. Description of the Prior Art

FIG. 5 shows the configuration of a conventional digital satellite broadcast receiver. The conventional digital satellite broadcast receiver 3′ is provided with a tuner circuit 4, a QPSK (quadrature phase shift keying) demodulator circuit 5′, a signal processing circuit 6, and a microcomputer 7′. A high-frequency signal output from a satellite is received by an antenna 1, and is then down-converted into an intermediate-frequency signal by an LNB (low-noise block converter) 2. The intermediate-frequency signal is then fed to a digital satellite broadcast receiver 3′.

Inside the digital satellite broadcast receiver 3′, the intermediate-frequency signal is fed to the tuner circuit 4. The tuning performed by the tuner circuit 4 is controlled according to channel frequency data S2, fed from the microcomputer 7′, of the channel that the user desires to receive. The gain of the tuner circuit 4 is controlled according to an AGC control signal S3 output from the QPSK demodulator circuit 5′. The intermediate-frequency signal is subjected to the tuning, amplification, and rectangular detection performed by the tuner circuit 4, and is thereby down-converted into an I baseband signal and a Q baseband signal.

The I and Q baseband signals are fed to the QPSK demodulator circuit 5′. The settings of the QPSK demodulator circuit 5′ are determined according to signal data (symbol rate, etc.) S4, fed from the microcomputer 7′, of the channel that the user desires to receive. The QPSK demodulator circuit 5′ converts the I and Q baseband signals into a digital signal, then subjects it to QPSK demodulation, then separates the demodulated digital data into packets, and then feeds them as transport stream data to the signal processing circuit 6. The signal processing circuit 6 reproduces image data, sound data, and other data on the basis of the transport stream data.

The gain of the tuner circuit 4 is so controlled as to make the output signal level of the tuner circuit 4 constant, and the gain of the QPSK demodulator circuit 5′ is so controlled as to make the output signal level of the QPSK demodulator circuit 5′ constant.

The microcomputer 7′ performs control as shown in a flow chart in FIG. 6. According to a tuning command signal SI fed from outside that indicates the channel that the user desires to receive, the microcomputer 7′ feeds channel frequency data S2 to the tuner circuit 4 (step #10). This permits the tuner circuit 4 to perform tuning according to the tuning command signal S1.

Subsequently, according to the tuning command signal S1, the microcomputer 7′ calculates the settings (such as that of the data transfer rate of the received signal) of the QPSK demodulator circuit 5′ (step #20), and then feeds those settings as signal data S4 to the QPSK demodulator circuit 5′ (step #30). This causes the QPSK demodulator circuit 5′ to be locked.

Subsequently, the microcomputer 7′ examines the transport stream data (step #40) to check, based on the transport stream data, whether the tuner circuit 4 is locked or not (step #100). If the tuner circuit 4 is not locked (No in step #100), i.e., if reception fails, the flow returns to step #10. By contrast, if the tuner circuit 4 is locked (Yes in step #100), i.e., if reception succeeds, the flow proceeds to step #110.

In step #110, whether there has been any change in the tuning command signal S1 or not is checked. If there has been no change in the tuning command signal S1 (No in step #110), the flow returns to step #40. This makes it possible to monitor whether the tuner circuit 4 has unlocked or not. By contrast, if there has been a change in the tuning command signal S1 (Yes in step #110), the flow returns to step #10.

As described above, in the conventional digital satellite broadcast receiver 3′, the settings of the QPSK demodulator circuit 5′ are changed according to the channel that the user desires to receive, but are never changed according to reception conditions. This occasionally makes it impossible to obtain satisfactory reception performance, for example, under poor reception conditions. Conversely, if the settings of the QPSK demodulator circuit 5′ are so determined as to suit poor reception conditions, it is then impossible to obtain satisfactory reception performance under normal reception conditions.

Incidentally, Japanese Patent Application Laid-Open No. S63-39291 discloses an analog satellite broadcast receiver that optimizes the received image under given reception conditions by varying the pass characteristic of the loop filter provided in an FM demodulator circuit according to the reception conditions. However, in this analog satellite broadcast receiver, it is the pass characteristic of the loop filter alone that is varied according to reception conditions, and therefore it is sometimes impossible to optimize the received image depending on reception conditions (for example, when the input signal to the FM demodulator has an excessively high level due to a nearby interfering wave).

### SUMMARY OF THE INVENTION

An object of the present invention is to provide a digital satellite broadcast receiver that offers satisfactory reception performance under any reception conditions.

To achieve the above object, according to the present invention, a digital satellite broadcast receiver is provided with a tuner circuit for selecting a broadcast signal of a desired channel from among signals fed thereto, a demodulator circuit for demodulating the broadcast signal selected by the tuner circuit, and a control circuit, having a reception condition evaluator, for controlling the demodulator circuit by varying the settings thereof according to the reception conditions.

### BRIEF DESCRIPTION OF THE DRAWINGS

This and other objects and features of the present invention will become clear from the following description, taken in conjunction with the preferred embodiments with reference to the accompanying drawings in which:

FIG. 1 is a diagram showing the configuration of a digital satellite broadcast receiver embodying the invention;

FIG. 2 is a diagram showing the configuration of the QPSK demodulator circuit provided in the digital satellite broadcast receiver shown in FIG. 1;

FIG. 3A is a flow chart showing, as one example, the sequence of operations executed by the microcomputer provided in the digital satellite broadcast receiver shown in FIG. 1, up to the step of outputting the settings for the QPSK demodulator circuit;

FIG. 3B is a flow chart showing the sequence of operations executed by the microcomputer provided in the digital satellite broadcast receiver shown in FIG. 1, after the step of outputting the settings for the QPSK demodulator circuit;

FIG. 4A is a flow chart showing, as another example, the sequence of operations executed by the microcomputer provided in the digital satellite broadcast receiver shown in FIG. 1, up to the step of outputting the settings for the QPSK demodulator circuit;

FIG. 4B is a flow chart showing the sequence of operations executed by the microcomputer provided in the digital satellite broadcast receiver shown in FIG. 1, after the step of outputting the settings for the QPSK demodulator circuit;

FIG. 5 is a diagram showing the configuration of a conventional digital satellite broadcast receiver; and

FIG. 6 is a flow chart showing the sequence of operations executed by the microcomputer provided in the conventional digital satellite broadcast receiver.

### DESCRIPTION OF THE PREFERRED EMBODIMENTS

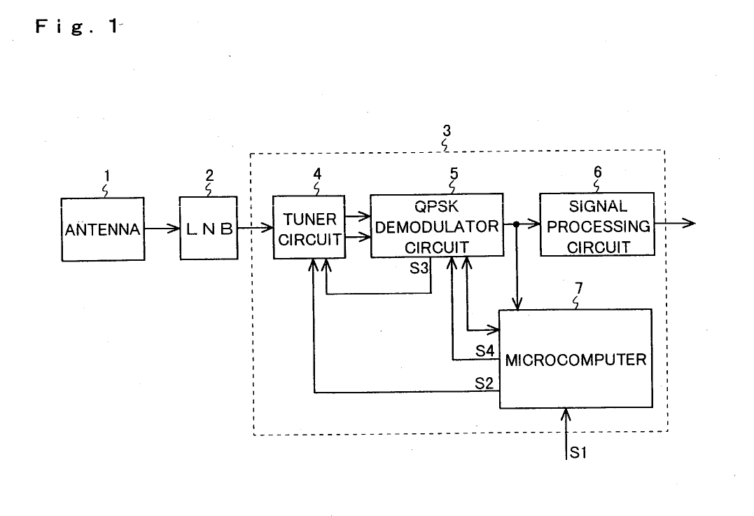

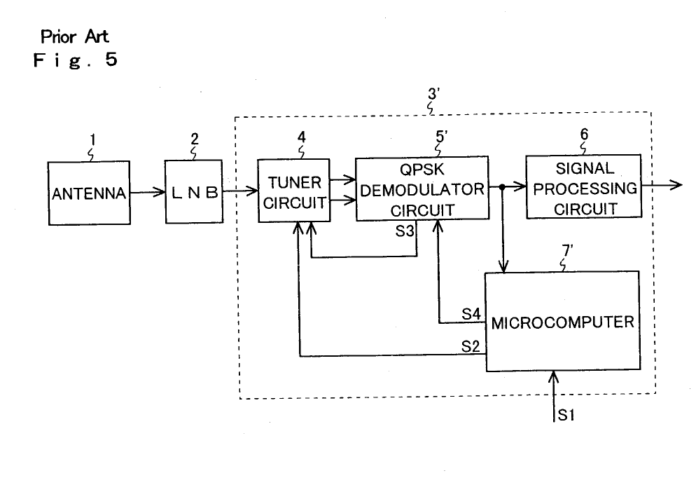

FIG. 1 shows the configuration of a digital satellite broadcast receiver embodying the invention. It is to be noted that, in FIG. 1, such circuit blocks as are found also in FIG. 5 are identified with the same reference numerals, and their detailed explanations will not be repeated.

The digital satellite broadcast receiver 3 of the invention is provided with a tuner circuit 4, a QPSK demodulator circuit 5, a signal processing circuit 6, and a microcomputer 7. An intermediate-frequency signal output from an LNB 2 is fed to the tuner circuit 4. The tuning performed by the tuner circuit 4 is controlled according to channel frequency data S2, fed from the microcomputer 7, of the channel that the user desires to receive. The gain of the tuner circuit 4 is controlled according to an AGC control signal S3 output from the QPSK demodulator circuit 5. The intermediate-frequency signal is subjected to the tuning, amplification, and rectangular detection performed by the tuner circuit 4, and is thereby down-converted into an I baseband signal and a Q baseband signal.

The I and Q baseband signals are fed to the QPSK demodulator circuit 5. The settings of the QPSK demodulator circuit 5 are determined according to signal data (symbol rate, etc.) S4, fed from the microcomputer 7, of the channel that the user desires to receive. The QPSK demodulator circuit 5 feeds reception conditions to the microcomputer 7. The microcomputer 7 controls the QPSK demodulator circuit 5 by varying the settings thereof according to the reception conditions. The QPSK demodulator circuit 5 converts the I and Q baseband signals into a digital signal, then subjects it to QPSK demodulation, then separates the demodulated digital data into packets, and then feeds them as transport stream data to the signal processing circuit 6. The signal processing circuit 6 reproduces image data, sound data, and other data on the basis of the transport stream data.

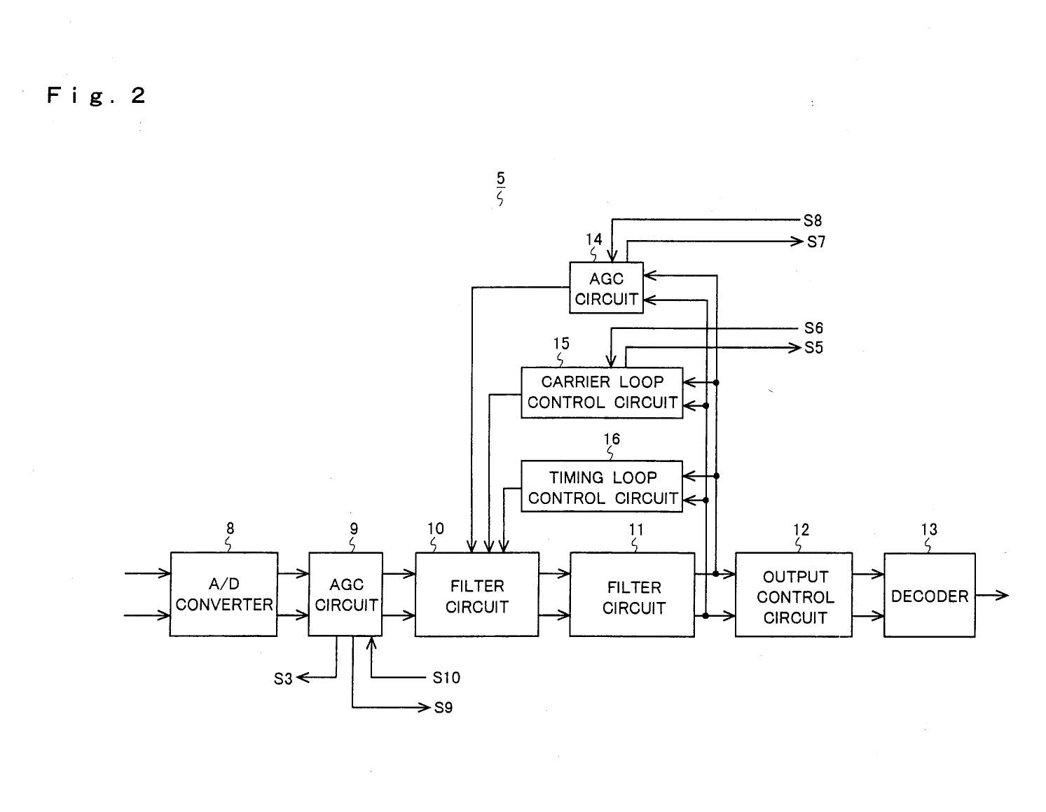

Now, examples of the reception conditions mentioned above will be described with reference to FIG. 2, which shows the configuration of the QPSK demodulator circuit 5. The QPSK demodulator circuit 5 is provided with an A/D converter 8, an AGC circuit 9, a filter circuit (decimation filter) 10, a filter circuit (matched filter) 11, an output control circuit 12, a decoder 13, an AGC circuit 14, a carrier loop control circuit 15, and a timing loop control circuit 16.

The I and Q baseband signals are converted by the A/D converter 8 into a digital signal, which is then fed through the AGC circuit 9 to the filter circuit 10. The AGC circuit 9 compares the output signal of the A/D converter 8 with a first reference level set as an internal parameter within the AGC circuit 9, produces an AGC control signal S3 according to the result of comparison, and controls the gain of the tuner circuit 4 (see FIG. 1) by the use of the AGC control signal S3. The filter circuit 10 adjusts the level of the signal fed from the AGC circuit 9, and thereby adjusts the gain and other internal parameters of the integrated circuit according to the signal condition in order to optimize the input signal level. The filter circuit 11 restricts the pass bandwidth of the signal fed from the filter circuit 10, and thereby adjusts the bandwidth of the transferred signal. The output control circuit 12 performs swapping of the signals (I and Q signals) fed from the filter circuit 11 and other operations. The decoder 13 demodulates the signal fed from the output control circuit 12, separates the demodulated digital data into packets, and feeds them as transport stream data to the signal processing circuit 6 (see FIG. 1).

The AGC circuit 14 compares the output signal of the filter circuit 11 with a second reference level set as an internal parameter within the AGC circuit 14, produces a control signal according to the result of comparison, and controls the gain of the filter circuit 10 by the use of the control signal. The carrier loop control circuit 15 permits the output signal of the filter circuit 11 to path therethrough with the bandwidth determined by a carrier loop constant set as an internal parameter within the carrier loop control circuit 15, and thereby feeds it to the filter circuit 10. The timing loop control circuit 16 pulls the transferred signal, i.e., the output signal of the filter circuit 11, toward the symbol rate.

The QPSK demodulator circuit 5 feeds, as reception conditions, the C/N (carrier-to-noise) ratio of the received signal and the control data on the AGC circuits 9 and 14 to the microcomputer 7.

First, the C/N ratio will be described. The C/N ratio represents the amount of noise in the received signal. Thus, the lower the C/N ratio, the poorer the reception conditions. The carrier loop control circuit 15 feeds data S5 of the C/N ratio to the microcomputer 7. Incidentally, the C/N ratio is calculated within the QPSK demodulator circuit 5, from variations in the I and Q signals. Specifically, the carrier loop control circuit 15 and the AGC circuits 9 and 14 detect variations in the convergence points in the constellation of the I and Q signals, and the C/N ratio is calculated from those variations in the convergence points.

When the C/N ratio is higher than or equal to a predetermined value, the microcomputer 7 recognizes that the reception conditions are normal, and feeds the carrier loop control circuit 15 with a control signal S6 that requests the carrier loop constant to be kept at its standard value. By contrast, when the C/N ratio is lower than the predetermined value, the microcomputer 7 recognizes that the reception conditions are not normal, and feeds the carrier loop control circuit 15 with a control signal S6 that requests the carrier loop constant to be made smaller than its standard value.

As the C/N ratio becomes lower, the amount of noise in the received signal increases, and thus the demodulation characteristics deteriorate, with the result that the BER (bit error rate) of the transport stream data output from the QPSK demodulator circuit 5 lowers. One cause for this deterioration of the demodulation characteristics is considered to be unstable capturing of the carrier by the carrier loop control circuit 15 under the influence of noise. Therefore, this inconvenience can be avoided by varying the setting of the carrier loop constant so as to narrow the bandwidth, because doing so helps stabilize the reproduction of the carrier. However, narrowing the carrier loop bandwidth results in lessening resistance to shock noise, making instantaneous unlocking more likely to occur in response to an external mechanical shock such as an impact or vibration. That is, there is a tradeoff between the demodulation characteristics obtained when the C/N ratio is low and resistance to shock noise.

In the conventional digital satellite broadcast receiver 3′, the carrier loop constant is fixed to secure sufficient resistance to shock noise at the cost of the demodulation characteristics obtained when the C/N ratio is low. By contrast, in this embodiment, when the microcomputer 7 recognizes that the C/N ratio is low, the carrier loop constant is made smaller to narrow the carrier loop bandwidth. This permits stable reception under poor reception conditions (i.e., when the C/N ratio is low) while securing satisfactory resistance to shock noise under normal reception conditions.

Next, the control data on the AGC circuits will be described. The AGC circuit 14 feeds AGC control data (data on the gain of the filter circuit 10) S7 to the microcomputer 7, and the AGC circuit 9 feeds AGC control data (data on the gain of the tuner circuit 4) S9 to the microcomputer 7. On the basis of the AGC control data S7 and S9 and the aforementioned data S5 of the C/N ratio, the microcomputer 7 recognizes the condition of a nearby interfering signal. When the level of the nearby interfering signal is lower than a predetermined value, the microcomputer 7 recognizes that the reception conditions are normal, and keeps the first reference level, which is an internal parameter of the AGC circuit 9, and the second reference level, which is an internal parameter of the AGC circuit 14, at their standard values. By contrast, when the level of the nearby interfering signal is higher than or equal to the predetermine value, the microcomputer 7 recognizes that the reception conditions are not normal. The microcomputer 7 then makes the first reference level, which is an internal parameter of the AGC circuit 9, lower than its standard value, and accordingly makes the second reference level, which is an internal parameter of the AGC circuit 14, higher than its standard value so that the QPSK demodulator circuit 5 yields the same output level as when those parameters are set at their standard values. The microcomputer 7 controls the setting of the first reference level, which is an internal parameter of the AGC circuit 9, by the use of a control signal S10, and controls the setting of the second reference level, which is an internal parameter of the AGC circuit 14, by the use of a control signal S8.

The AGC circuit 9 produces the AGC control signal S3 on the basis of the levels of the I and Q baseband signals, which are the desired signals, and therefore, if there is an interfering wave near the desired signals within the transferred bandwidth, the signals fed to the A/D converter 8 have greater amplitudes than the desired signals themselves owing to the interfering signal.

In the conventional digital satellite broadcast receiver 3′, the first reference level, which is an internal parameter of the AGC circuit 9, is fixed, and therefore the levels of the I and Q baseband signals are fixed This sometimes results in excessive input levels to the A/D converter 8, causing its saturation. When the A/D converter 8 is saturated by excessive input levels, the error characteristics of the output signal of the QPSK demodulator circuit 5 deteriorates. By contrast, in this embodiment, when the level of an interfering signal is high, the first reference level, which is an internal parameter of the AGC circuit 9, is made lower. Thus, when the level of an interfering signal is high, the levels of the I and Q baseband signals become lower. This prevents saturation of the A/D converter 8 by excessive input levels, and thus prevents deterioration of the output signal of the QPSK demodulator circuit 5. In addition, as the first reference level, which is an internal parameter of the AGC circuit 9, is made lower and thus the levels of the I and Q baseband signals become lower, so the second reference level, which is an internal parameter of the AGC circuit 14, is made higher in order to keep constant the level of the transport stream data output from the QPSK demodulator circuit 5. This makes it possible to obtain satisfactory reception performance even when there is a nearby interfering signal.

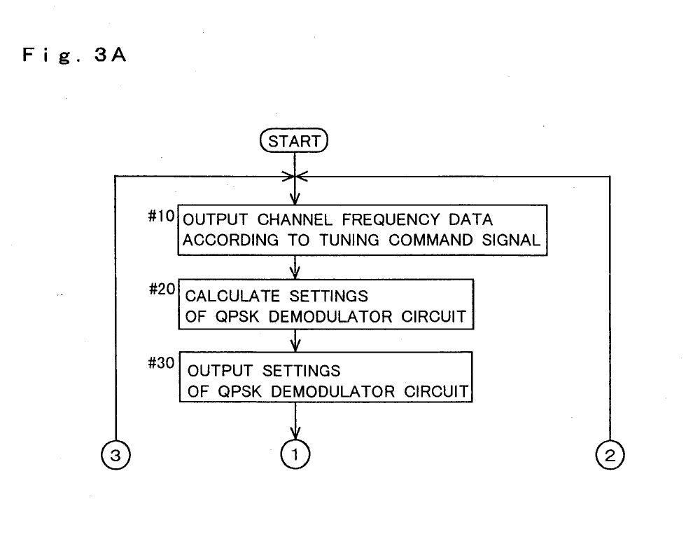

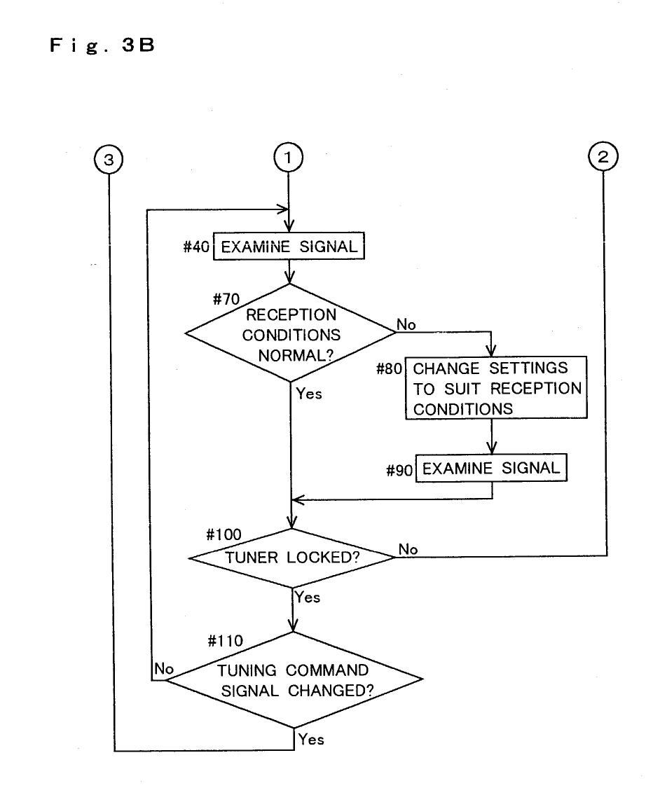

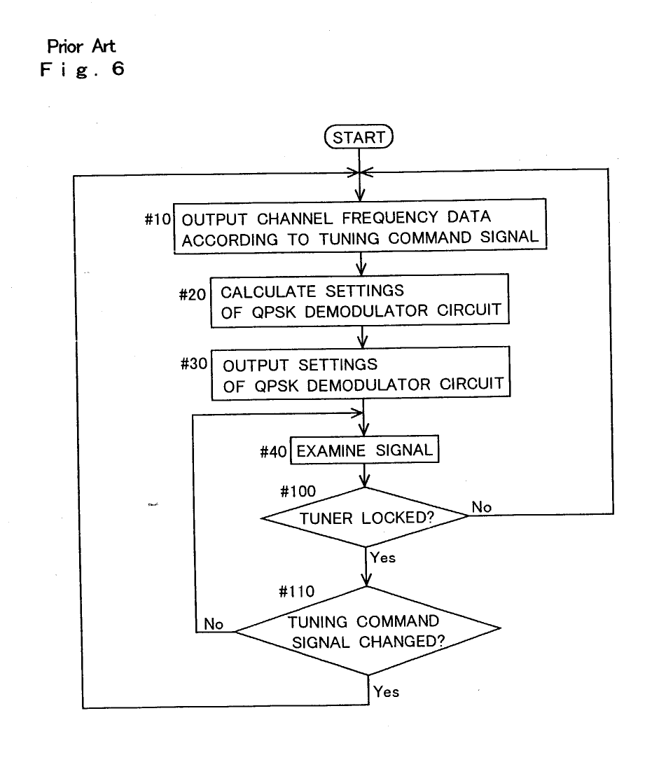

The microcomputer 7 achieves the control described above by executing operations as shown in a flow chart in FIGS. 3A and 3B. It is to be noted that, in FIGS. 3A and 3B, such steps as are found also in FIG. 6 are identified with the same step numbers. FIG. 3A shows the operations executed up to the step of outputting the settings of the QPSK demodulator circuit, and FIG. 3B shows the operations executed after the step of outputting the settings of the QPSK demodulator circuit. The microcomputer 7 feeds the tuner circuit 4 with channel frequency data S2 according to a tuning command signal SI fed from outside that indicates the channel that the user desires to receive (step #10 in FIG. 3A). This permits the tuner circuit 4 to perform tuning according to the tuning command signal SI.

Subsequently, according to the tuning command signal SI, the microcomputer 7 calculates the settings (such as that of the data transfer rate of the received signal) of the QPSK demodulator circuit 5 (step #20), and then feeds those settings as signal data S4 to the QPSK demodulator circuit 5 (step #30). This causes the QPSK demodulator circuit 5 to be locked.

Subsequently, as shown in FIG. 3B, the microcomputer 7 examines the transport stream data (step #40), and then checks whether the reception conditions are normal or not on the basis of the data S5 of the C/N ratio and the AGC control data S7 and S9 (step #70). If the reception conditions are normal (Yes in step #70), the settings of the QPSK demodulator circuit 5 are made equal to their standard settings, and then the flow proceeds to step #100. By contrast, if the reception conditions are not normal (No in step #70), the settings of the QPSK demodulator circuit 5 is changed from their standard settings to those that suit the reception conditions (step #80), then the transport stream data are examined again (step #90), and then the flow proceeds to step #100.

In step #100, based on the transport stream data, whether the tuner circuit 4 is locked or not is checked. If the tuner circuit 4 is not locked (No in step #100), i.e., if reception fails, the flow returns to step #10 shown in FIG. 3A. Here, when the flow returns to step #10, if the settings of the QPSK demodulator circuit 5 are not standard, they are restored to their standard settings. By contrast, if the tuner circuit 4 is locked (Yes in step #100), i.e., if reception succeeds, the flow proceeds to step #110.

In step #110, whether there has been any change in the tuning command signal SI or not is checked. If there has been no change in the tuning command signal SI (No in step #110), the flow returns to step #40. This makes it possible to monitor whether the tuner circuit has unlocked or not and change the settings of the QPSK demodulator circuit 5 according to reception conditions whenever necessary. By contrast, if there has been a change in the tuning command signal SI (Yes in step #110), the flow returns to step #10 shown in FIG. 3A. Here, when the flow returns to step #10, if the settings of the QPSK demodulator circuit 5 are not standard, they are restored to their standard settings.

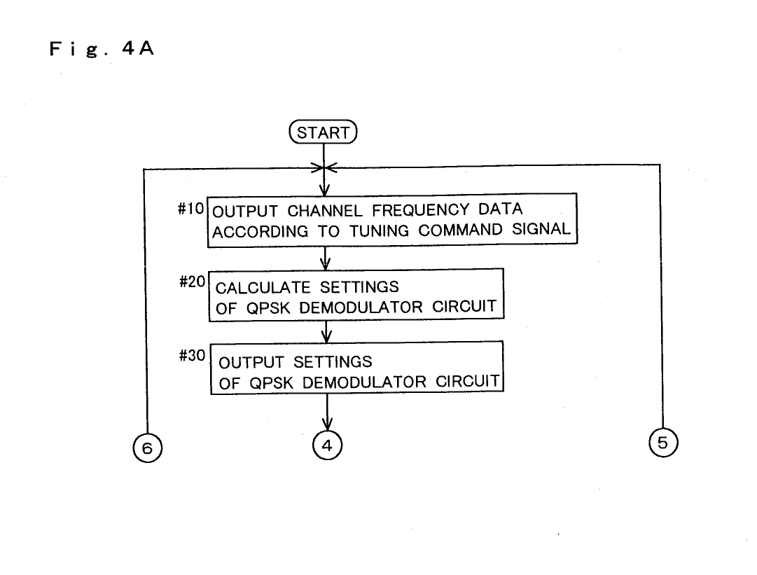

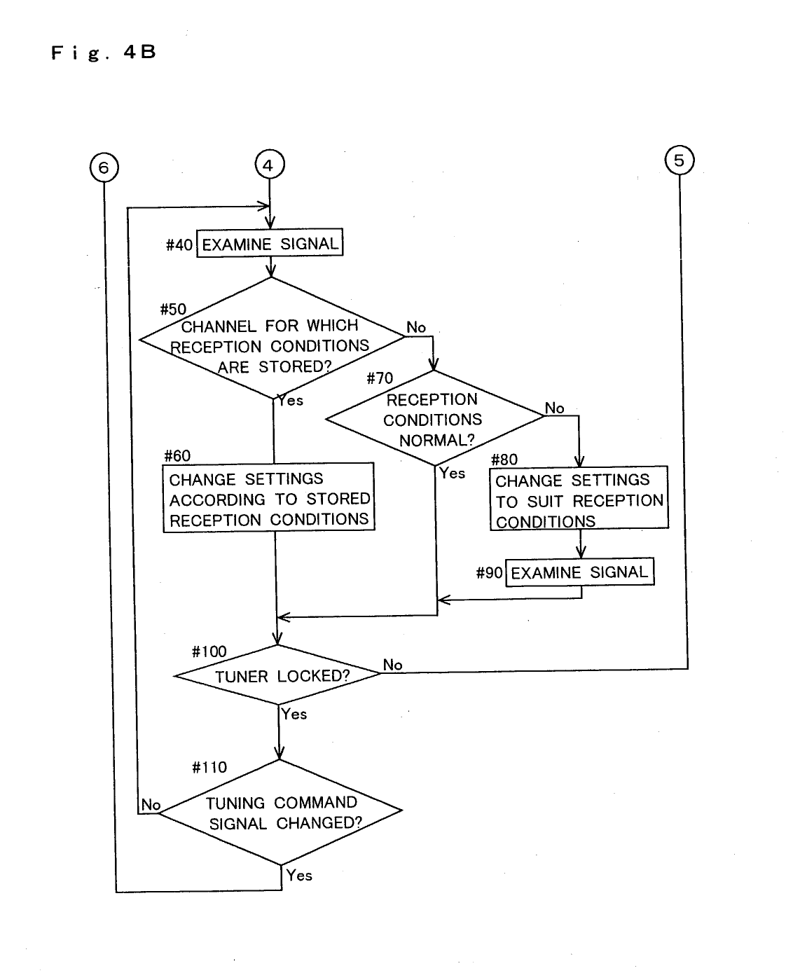

Alternatively, the microcomputer 7 may execute operations as shown in a flow chart in FIGS. 4A and 4B. In this case, the microcomputer 7 incorporates a memory (not illustrated) for storing reception conditions. It is to be noted that, in FIGS. 4A and 4B, such steps as are found also in FIGS. 3A and 3B are identified with the same step numbers. FIG. 4A shows the operations executed up to the step of outputting the settings of the QPSK demodulator circuit, and FIG. 4B shows the operations executed after the step of outputting the settings of the QPSK demodulator circuit.

Steps #10 to #40 are the same as in the flow chart shown in FIGS. 3A and 3B, and therefore their explanations will be omitted. On completion of step #40, the flow proceeds to step #50.

In step #50, whether or not the channel that the user desires to receives is a channel for which reception conditions are stored in the memory incorporated in the microcomputer 7 is checked. If the channel that the user desires to receives is a channel for which reception conditions are stored in the memory incorporated in the microcomputer 7 (Yes in step #50), the settings of the QPSK demodulator circuit 5 are controlled according to the reception conditions stored in the memory (step #60), and then the flow proceeds to step #100.

By contrast, if the channel that the user desires to receives is not a channel for which reception conditions are stored in the memory incorporated in the microcomputer 7 (No in step #50), then, on the basis of the data S5 of the C/N ratio and the AGC control data S7 and S9, whether the reception conditions are normal or not (step #70) is checked. At this time, the reception conditions evaluated for the channel are stored in the memory. If the reception conditions are normal (Yes in step #70), the settings of the QPSK demodulator circuit 5 are made equal to their standard settings, and then the flow proceeds to step #100. By contrast, if the reception conditions are not normal (No in step #70), the settings of the QPSK demodulator circuit 5 is changed from their standard settings to those that suit the and then conditions (step #80), then the transport stream data are examined again (step #90), and then the flow proceeds to step #100.

Steps #100 to #110 are the same as in the flow chart shown in FIG. 3B, and therefore their explanations will be omitted.

According to the flow chart shown in FIGS. 4A and 4B, once reception conditions are evaluated for a given channel, there is no need any longer to evaluate reception conditions for that channel again on the basis of the data S5 of the C/N ratio and the AGC control data S7 and S9. This helps alleviate the burden on the microcomputer 7.

What is claimed is:

1. A digital satellite broadcast receiver comprising:
a tuner circuit for selecting a broadcast signal of a desired channel from among signals fed thereto;
a demodulator circuit for demodulating the broadcast signal selected by the tuner circuit; and
a control circuit for controlling the demodulator circuit,
wherein the control circuit has a reception condition evaluator for evaluating a reception condition, and varies a setting of the demodulator circuit according to the reception condition.

2. The digital satellite broadcast receiver according to claim 1,
wherein the demodulator circuit has an automatic gain control circuit for controlling a gain of the tuner circuit and a gain of the demodulator circuit individually, and
the control circuit varies a setting of the automatic gain control circuit according to the reception condition.

3. The digital satellite broadcast receiver according to claim 1,
wherein the reception condition evaluator evaluates the reception condition based on a C/N ratio of the received signal, and
the control circuit varies a setting of a carrier loop bandwidth of the demodulator circuit according to the reception condition.

4. The digital satellite broadcast receiver according to claim 1,
wherein the demodulator circuit has an automatic gain control circuit for controlling a gain of the tuner circuit and a gain of the demodulator circuit individually, and
the control circuit varies a setting of the automatic gain control circuit and a setting of a carrier loop bandwidth of the demodulator circuit according to the reception condition.

5. The digital satellite broadcast receiver according to claim 1, further comprising:
a memory for storing the reception condition evaluated by the reception condition evaluator,
wherein the control circuit varies the setting of the demodulator circuit according to the reception condition stored in the memory.

6. The digital satellite broadcast receiver according to claim 5,
wherein the demodulator circuit has an automatic gain control circuit for controlling a gain of the tuner circuit and a gain of the demodulator circuit individually, and
the control circuit varies a setting of the automatic gain control circuit according to the reception condition stored in the memory.

7. The digital satellite broadcast receiver according to claim 5,
wherein the reception condition evaluator evaluates the reception condition based on a C/N ratio of the received signal, and
the control circuit varies a setting of a carrier loop bandwidth of the demodulator circuit according to the reception condition stored in the memory.

8. The digital satellite broadcast receiver according to claim 5,
wherein the demodulator circuit has an automatic gain control circuit for controlling a gain of the tuner circuit and a gain of the demodulator circuit individually, and
the control circuit varies a setting of the automatic gain control circuit and a setting of a carrier loop bandwidth of the demodulator circuit according to the reception condition stored in the memory.

9. The digital satellite broadcast receiver according to claim 5,
wherein the memory stores on a channel-by-channel basis the reception condition evaluated by the reception condition evaluator, and
the control circuit varies the setting of the demodulator circuit according to the reception condition stored on a channel-by-channel basis in the memory.

10. The digital satellite broadcast receiver according to claim 9,
wherein the demodulator circuit has an automatic gain control circuit for controlling a gain of the tuner circuit and a gain of the demodulator circuit individually, and
the control circuit varies a setting of the automatic gain control circuit according to the reception condition stored on a channel-by-channel basis in the memory.

11. The digital satellite broadcast receiver according to claim 9,
wherein the reception condition evaluator evaluates the reception condition based on a C/N ratio of the received signal, and
the control circuit varies a setting of a carrier loop bandwidth of the demodulator circuit according to the reception condition stored on a channel-by-channel basis in the memory.

12. The digital satellite broadcast receiver according to claim 9,
wherein the demodulator circuit has an automatic gain control circuit for controlling a gain of the tuner circuit and a gain of the demodulator circuit individually, and
the control circuit varies a setting of the automatic gain control circuit and a setting of a carrier loop bandwidth of the demodulator circuit according to the reception condition stored on a channel-by-channel basis in the memory.
